(19) United States
(12) Patent Application Publication
(10) Pub. No.: US 2022/0112120 A1
(43) Pub. Date: Apr. 14, 2022

(54) GLASS, AND GLASS PRODUCT AND PREPARATION METHOD THEREFOR

(71) Applicant: CDGM GLASS CO., LTD, Chengdu (CN)

(72) Inventor: Wei SUN, Chengdu (CN)

(21) Appl. No.: 17/645,524

(22) Filed: Dec. 22, 2021

Related U.S. Application Data
(63) Continuation of application No. PCT/CN2020/088910, filed on May 7, 2020.

(30) Foreign Application Priority Data
Jun. 25, 2019 (CN) 201910555329.7

(51) Int. Cl. C03C 3/21; C03C 15/00

(52) U.S. Cl. CPC C03C 3/21; C03C 15/00

(57) ABSTRACT

The present disclosure provides glass, which has a composition expressed in terms of mole percent, comprising: P₂O₅: 38 to 65%; Al₂O₃: 2 to 15%; CuO: 8 to 25%; Rn₂O: 5 to 40%; RO: 1 to 30%; and V₂O₅: 0 to 3%, wherein Li₂O/Rn₂O is 0.4 to 1.0, and (Li₂O+CuO)/P₂O₅ is 0.3 to 1.2; wherein the content of Rn₂O is the total content of Li₂O, Na₂O, and K₂O; and wherein the content of RO is the total content of MgO, CaO, SrO, and BaO. Through reasonable component design, the glass obtained by the present disclosure has excellent crystallization resistance in the case of high Cu content; moreover, the glass of the present disclosure is suitable for chemical strengthening, and the glass products obtained after chemical strengthening have excellent bending strength.

### TECHNICAL FIELD

The present disclosure relates to glass, in particular to a near-infrared light absorbing glass, a glass product and a preparation method therefor.

### BACKGROUND

In recent years, as the scope of spectral sensitivity of semiconductor imaging elements such as CCD and CMOS for digital cameras, mobile phones capable of taking pictures, and VTR cameras has been developed to cover from the visible region to the near-infrared region around 1,100 nm, optical filters absorbing the light from the near-infrared region may provide a visibility similar to human visibility. Therefore, the demand for optical filters for correction of chromatic sensitivity is growing, which imposes higher requirements on near-infrared light absorbing glass used to manufacture such optical filters, that is, such glass is required to have excellent transmission characteristics in the visible region; in addition, due to the application of near-infrared light absorbing glass in the fields of smart phones and the like, higher requirements are also put forward on the bending strength and other properties of the glass.

The miniaturization and weight-lightening of photoelectric end products have promoted the reduction in thickness of near-infrared light absorbing glass. However, if the glass is directly thinned, the near-infrared light absorbing property of the glass will also be reduced, and the desired spectrophotometric characteristics may not be obtained. Thus, it is often necessary to increase the content of the coloring component Cu²⁺ to compensate for the reduction in light absorbing property due to thinning, but high concentration of Cu²⁺ in the near-infrared light absorbing glass changes the valence state of Cu, which makes it difficult to obtain the desired light absorbing property. Furthermore, if the amount of Cu is increased, the crystallization resistance of the glass will be lower, and crystals are likely to be formed in the glass.

### SUMMARY

For the above reasons, the technical problem to be solved by the present disclosure is to provide glass which can solve at least one of the above-mentioned problems, and particularly to provide glass with excellent crystallization resistance. The technical solutions adopted in the present disclosure to solve the technical problem are as follows:

(1) Glass, which has a composition expressed in terms of mole percent, comprising: P₂O₅: 38 to 65%; Al₂O₃: 2 to 15%; CuO: 8 to 25%; Rn₂O: 5 to 40%; RO: 1 to 30%; and V₂O₅: 0 to 3%, wherein Li₂O/Rn₂O is 0.4 to 1.0, and (Li₂O+CuO)/P₂O₅ is 0.3 to 1.2; wherein the content of Rn₂O is the total content of Li₂O, Na₂O, and K₂O; and wherein the content of RO is the total content of MgO, CaO, SrO, and BaO.

(2) The glass according to (1), which has a composition expressed in terms of mole percent, further comprising: SiO₂: 0 to 10%; and/or B₂O₃: 0 to 10%; and/or ZnO: 0 to 8%; and/or Ln₂O₃: 0 to 10%; and/or ZrO₂: 0 to 10%, wherein Ln₂O₃ is one or more of La₂O₃, Gd₂O₃, Y₂O₃, and Yb₂O₃.

(3) Glass, which has a composition expressed in terms of mole percent, comprising P₂O₅, Al₂O₃, CuO, and Rn₂O, wherein Li₂O/Rn₂O is 0.4 to 1.0, and (Li₂O+CuO)/P₂O₅ is 0.3 to 1.2; wherein the content of Rn₂O is the total content of Li₂O, Na₂O, and K₂O; and wherein the glass has an upper limit temperature of crystallization of 1050° C. or lower.

(4) The glass according to any one of (1) to (3), which has a composition expressed in terms of mole percent, comprising: P₂O₅: 40 to 60%; and/or Al₂O₃: 5 to 13%; and/or CuO: 10 to 22%; and/or Rn₂O: 8 to 30%; and/or RO: 2 to 25%; and/or V₂O₅: 0.05 to 2%; and/or SiO₂: 0 to 5%; and/or B₂O₃: 0 to 5%; and/or ZnO: 0 to 5%; and/or Ln₂O₃: 0 to 5%; and/or ZrO₂: 0 to 5%, wherein the content of Rn₂O is the total content of Li₂O, Na₂O, and K₂O; wherein the content of RO is the total content of MgO, CaO, SrO, and BaO; and wherein Ln₂O₃ is one or more of La₂O₃, Gd₂O₃, Y₂O₃, and Yb₂O₃.

(5) The glass according to any one of (1) to (3), which has a composition expressed in terms of mole percent, wherein Li₂O/Rn₂O is 0.5 to 1.0, and/or BaO/MgO is 0.05 to 5.0, and/or Li₂O/CuO is 0.3 to 3.0, and/or Na₂O+K₂O is 10% or less, and/or (Li₂O+CuO)/P₂O₅ is 0.4 to 1.0, and/or 10×V₂O₅/Li₂O is 0.02 to 3.0, and/or RO/CuO is 2.0 or less; wherein the content of Rn₂O is the total content of Li₂O, Na₂O, and K₂O; and wherein the content of RO is the total content of MgO, CaO, SrO, and BaO.

(6) The glass according to any one of (1) to (3), which has a composition expressed in terms of mole percent, comprising: P₂O₅: 45 to 55%; and/or Al₂O₃: 6 to 11%; and/or CuO: 14 to 20%; and/or Rn₂O: 10 to 25%; and/or RO: 4 to 20%; and/or V₂O₅: 0.1 to 1%; and/or SiO₂: 0 to 2%; and/or B₂O₃: 0 to 2%; and/or ZnO: 0 to 2%; and/or Ln₂O₃: 0 to 2%; and/or ZrO₂: 0 to 2%, wherein the content of Rn₂O is the total content of Li₂O, Na₂O, and K₂O; wherein the content of RO is the total content of MgO, CaO, SrO, and BaO; and wherein Ln₂O₃ is one or more of La₂O₃, Gd₂O₃, Y₂O₃, and Yb₂O₃.

(7) The glass according to any one of (1) to (3), which has a composition expressed in terms of mole percent, wherein Li₂O/Rn₂O is 0.7 to 1.0, and/or BaO/MgO is 0.1 to 3.0, and/or Li₂O/CuO is 0.5 to 2.0, and/or Na₂O+K₂O is 8% or less, and/or (Li₂O+CuO)/P₂O₅ is 0.5 to 0.8, and/or 10×V₂O₅/Li₂O is 0.05 to 2.0, and/or RO/CuO is 0.2 to 1.5; wherein the content of Rn₂O is the total content of Li₂O, Na₂O, and K₂O; and wherein the content of RO is the total content of MgO, CaO, SrO, and BaO.

(8) The glass according to any one of (1) to (3), which has a composition expressed in terms of mole percent, wherein Li₂O/Rn₂O is 0.8 to 1.0, and/or BaO/MgO is 0.15 to 1.0, and/or Li₂O/CuO is 0.8 to 1.5, and/or Na₂O+K₂O is 5% or less, and/or 10×V₂O₅/Li₂O is 0.1 to 0.8, and/or RO/CuO is 0.3 to 1.0; wherein the content of Rn₂O is the total content of Li₂O, Na₂O, and K₂O; and wherein the content of RO is the total content of MgO, CaO, SrO, and BaO.

(9) The glass according to any one of (1) to (3), which has a composition expressed in terms of mole percent, wherein Li₂O: 6 to 30%, preferably Li₂O: 10 to 22%, and more preferably Li₂O: 12 to 20%; and/or Na₂O: 0 to 10%, preferably Na₂O: 0 to 5%, and more preferably Na₂O: 0 to 2%; and/or K₂O: 0 to 10%, preferably K₂O: 0 to 5%, and more preferably K₂O: 0 to 2%; and/or MgO: 1 to 15%, preferably MgO: 2 to 12%, and more preferably MgO: 4 to 10%; and/or CaO: 0 to 8%, preferably CaO: 0 to 5%, and more preferably CaO: 0 to 3%; and/or SrO: 0 to 8%, preferably SrO: 0 to 5%, and more preferably SrO: 0 to 3%; and/or BaO: 0 to 10%, preferably BaO: 0.5 to 8%, and more preferably BaO: 1 to 6%.

(10) The glass according to any one of (1) to (3), which has a composition expressed in terms of mole percent, wherein (Li₂O+BaO+CuO)/(Na₂O+K₂O+MgO+CaO+SrO) is 2.0 to 17.0, preferably (Li₂O+BaO+CuO)/(Na₂O+K₂O+MgO+CaO+SrO) is 3.0 to 12.0, and more preferably (Li₂O+BaO+CuO)/(Na₂O+K₂O+MgO+CaO+SrO) is 4.0 to 10.0.

(11) The glass according to any one of (1) to (3), which has a composition expressed in terms of mole percent, comprising: F: 0 to 5%; and/or Fe: 0 to 5%; and/or a refining agent: 0 to 1%, wherein the refining agent is one or more of Sb₂O₃, SnO₂, SnO, and CeO₂.

(12) The glass according to any one of (1) to (3), which has a composition not comprising SiO₂; and/or not comprising B₂O₃; and/or not comprising ZnO; and/or not comprising ZrO₂; and/or not comprising F; and/or not comprising Fe.

(13) The glass according to any one of (1) to (3), of which the upper limit temperature of crystallization is 1050° C. or lower, preferably 1040° C. or lower, and more preferably 1030° C. or lower; and/or the transition temperature T_{g} is 405° C. or higher, preferably 410° C. or higher, and more preferably 415 to 450° C.; and/or the density p is 3.1 g/cm³ or less, preferably 3.0 g/cm³ or less, and more preferably 2.9 g/cm³ or less; and/or the coefficient of thermal expansion α_{20-120° C.} is 98×10⁻⁷/K or less, preferably 93×10⁻⁷/K or less, and more preferably 90×10⁻⁷/K or less.

(14) The glass according to any one of (1) to (3), wherein the wavelength λ₅₀, at which the transmittance of the glass with a thickness of 0.11 mm reaches 50%, is 622 to 650 nm, preferably 628 to 645 nm, and more preferably 630 to 640 nm.

(15) The glass according to any one of (1) to (3), wherein the transmittance τ₄₀₀ of the 0.11 mm-thick glass at 400 nm is 73% or more, preferably 76% or more, and more preferably 78% or more; and/or the transmittance τ_{1,100} at 1,100 nm is 15% or less, preferably 13% or less, and more preferably 10% or less.

The present disclosure further provides a glass product:

(16) A glass product, which has a composition expressed in terms of mole percent, comprising: P₂O₅: 38 to 65%; Al₂O₃: 2 to 15%; CuO: 8 to 25%; Rn₂O: 5 to 40%; RO: 1 to 30%; and V₂O₅: 0 to 3%, wherein Li₂O/Rn₂O is 0.4 to 1.0, and (Li₂O+CuO)/P₂O₅ is 0.3 to 1.2; wherein the content of Rn₂O is the total content of Li₂O, Na₂O, and K₂O; and wherein the content of RO is the total content of MgO, CaO, SrO, and BaO.

(17) The glass product according to (16), which has a composition expressed in terms of mole percent, further comprising: SiO₂: 0 to 10%; and/or B₂O₃: 0 to 10%; and/or ZnO: 0 to 8%; and/or Ln₂O₃: 0 to 10%; and/or ZrO₂: 0 to 10%, wherein Ln₂O₃ is one or more of La₂O₃, Gd₂O₃, Y₂O₃, and Yb₂O₃.

(18) The glass product according to (16) or (17), which has a composition expressed in terms of mole percent, comprising: P₂O₅: 40 to 60%; and/or Al₂O₃: 5 to 13%; and/or CuO: 10 to 22%; and/or Rn₂O: 8 to 30%; and/or RO: 2 to 25%; and/or V₂O₅: 0.05 to 2%; and/or SiO₂: 0 to 5%; and/or B₂O₃: 0 to 5%; and/or ZnO: 0 to 5%; and/or Ln₂O₃: 0 to 5%; and/or ZrO₂: 0 to 5%, wherein the content of Rn₂O is the total content of Li₂O, Na₂O, and K₂O; wherein the content of RO is the total content of MgO, CaO, SrO, and BaO; and wherein Ln₂O₃ is one or more of La₂O₃, Gd₂O₃, Y₂O₃, and Yb₂O₃.

(19) The glass product according to (16) or (17), which has a composition expressed in terms of mole percent, wherein Li₂O/Rn₂O is 0.5 to 1.0, and/or BaO/MgO is 0.05 to 5.0, and/or Li₂O/CuO is 0.3 to 3.0, and/or Na₂O+K₂O is 10% or less, and/or (Li₂O+CuO)/P₂O₅ is 0.4 to 1.0, and/or 10×V₂O₅/Li₂O is 0.02 to 3.0, and/or RO/CuO is 2.0 or less; wherein the content of Rn₂O is the total content of Li₂O, Na₂O, and K₂O; and wherein the content of RO is the total content of MgO, CaO, SrO, and BaO.

(20) The glass product according to (16) or (17), which has a composition expressed in terms of mole percent, comprising: P₂O₅: 45 to 55%; and/or Al₂O₃: 6 to 11%; and/or CuO: 14 to 20%; and/or Rn₂O: 10 to 25%; and/or RO: 4 to 20%; and/or V₂O₅: 0.1 to 1%; and/or SiO₂: 0 to 2%; and/or B₂O₃: 0 to 2%; and/or ZnO: 0 to 2%; and/or Ln₂O₃: 0 to 2%; and/or ZrO₂: 0 to 2%, wherein the content of Rn₂O is the total content of Li₂O, Na₂O, and K₂O; wherein the content of RO is the total content of MgO, CaO, SrO, and BaO; and wherein Ln₂O₃ is one or more of La₂O₃, Gd₂O₃, Y₂O₃, and Yb₂O₃.

(21) The glass product according to (16) or (17), which has a composition expressed in terms of mole percent, wherein Li₂O/Rn₂O is 0.7 to 1.0, and/or BaO/MgO is 0.1 to 3.0, and/or Li₂O/CuO is 0.5 to 2.0, and/or Na₂O+K₂O is 8% or less, and/or (Li₂O+CuO)/P₂O₅ is 0.5 to 0.8, and/or 10×V₂O₅/Li₂O is 0.05 to 2.0, and/or RO/CuO is 0.2 to 1.5; wherein the content of Rn₂O is the total content of Li₂O, Na₂O, and K₂O; and wherein the content of RO is the total content of MgO, CaO, SrO, and BaO.

(22) The glass product according to (16) or (17), which has a composition expressed in terms of mole percent, wherein Li₂O/Rn₂O is 0.8 to 1.0, and/or BaO/MgO is 0.15 to 1.0, and/or Li₂O/CuO is 0.8 to 1.5, and/or Na₂O+K₂O is 5% or less; and/or 10×V₂O₅/Li₂O is 0.1 to 0.8, and/or RO/CuO is 0.3 to 1.0; wherein the content of Rn₂O is the total content of Li₂O, Na₂O, and K₂O; and wherein the content of RO is the total content of MgO, CaO, SrO, and BaO.

(23) The glass product according to (16) or (17), which has a composition expressed in terms of mole percent, wherein Li₂O: 6 to 30%, preferably Li₂O: 10 to 22%, and more preferably Li₂O: 12 to 20%; and/or Na₂O: 0 to 10%, preferably Na₂O: 0 to 5%, and more preferably Na₂O: 0 to 2%; and/or K₂O: 0 to 10%, preferably K₂O: 0 to 5%, and more preferably K₂O: 0 to 2%; and/or MgO: 1 to 15%, preferably MgO: 2 to 12%, and more preferably MgO: 4 to 10%; and/or CaO: 0 to 8%, preferably CaO: 0 to 5%, and more preferably CaO: 0 to 3%; and/or SrO: 0 to 8%, preferably SrO: 0 to 5%, and more preferably SrO: 0 to 3%; and/or BaO: 0 to 10%, preferably BaO: 0.5 to 8%, and more preferably BaO: 1 to 6%.

(24) The glass product according to (16) or (17), which has a composition expressed in terms of mole percent, wherein (Li₂O+BaO+CuO)/(Na₂O+K₂O+MgO+CaO+SrO) is 2.0 to 17.0, preferably (Li₂O+BaO+CuO)/(Na₂O+K₂O+MgO+CaO+SrO) is 3.0 to 12.0, and more preferably (Li₂O+BaO+CuO)/(Na₂O+K₂O+MgO+CaO+SrO) is 4.0 to 10.0.

(25) The glass product according to (16) or (17), which has a composition expressed in terms of mole percent, comprising: F: 0 to 5%; and/or Fe: 0 to 5%; and/or a refining agent: 0 to 1%, wherein the refining agent is one or more of Sb₂O₃, SnO₂, SnO, and CeO₂.

(26) The glass product according to (16) or (17), which has a composition not comprising SiO₂; and/or not comprising B₂O₃; and/or not comprising ZnO; and/or not comprising ZrO₂; and/or not comprising F; and/or not comprising Fe.

(27) The glass product according to (16) or (17), of which the upper limit temperature of crystallization is 1050° C. or lower, preferably 1040° C. or lower, and more preferably 1030° C. or lower; and/or the transition temperature T_{g} is 405° C. or higher, preferably 410° C. or higher, and more preferably 415 to 450° C.; and/or the density p is 3.1 g/cm³ or less, preferably 3.0 g/cm³ or less, and more preferably 2.9 g/cm³ or less; and/or the coefficient of thermal expansion α_{20-120° C.} is 98×10⁻⁷/K or less, preferably 93×10⁻⁷/K or less, and more preferably 90×10⁻⁷/K or less.

(28) The glass product according to (16) or (17), wherein the wavelength λ₅₀, at which the transmittance of the glass product with a thickness of 0.11 mm reaches 50%, is 622 to 650 nm, preferably 628 to 645 nm, and more preferably 630 to 640 nm.

(29) The glass product according to (16) or (17), wherein the transmittance τ₄₀₀ of the 0.11 mm-thick glass product at 400 nm is 73% or more, preferably 76% or more, and more preferably 78% or more; and/or the transmittance τ_{1,100} at 1,100 nm is 15% or less, preferably 13% or less, and more preferably 10% or less.

(30) The glass product according to (16) or (17), the bending strength a of the 0.11 mm-thick glass product is 400 MPa or more, preferably 450 MPa or more, more preferably 500 MPa or more, and further preferably 520 to 700 MPa.

The present disclosure further provides a glass element:

(31) A glass element, containing the glass according to any one of (1) to (15), or containing the glass product according to any one of (16) to (30).

The present disclosure further provides an optical filter:

(32) An optical filter, containing the glass according to any one of (1) to (15), or containing the glass product according to any one of (16) to (30), or containing the glass element according to (31).

The present disclosure further provides a device:

(33) A device, containing the glass according to any one of (1) to (15), or containing the glass product according to any one of (16) to (30), or containing the glass element according to (31), or containing the optical filter according to (32).

The present disclosure further provides a method for preparing a glass product:

(34) A method for preparing a glass product, wherein glass is processed into a glass formed body with a certain thickness, and then the glass formed body is placed in an etching solution formed from NaOH and/or KOH solution.

(35) The method for preparing a glass product according to (34), wherein the concentration of the etching solution is 3 to 40%, preferably 5 to 30%, and more preferably 5 to 20%; and/or the etching temperature is 50 to 150° C., preferably 60 to 120° C., and more preferably 70 to 110° C.; and/or the chemical etching time is 1 to 60 minutes, preferably 1 to 40 minutes, and more preferably 2 to 30 minutes.

The advantageous effects of the present disclosure are as follows: through reasonable component design, the glass obtained by the present disclosure has excellent crystallization resistance in the case of high Cu content; moreover, the glass of the present disclosure is suitable for chemical strengthening, and the glass products obtained after chemical strengthening have excellent bending strength.

### DETAILED DESCRIPTION

The embodiments of the glass and the glass product of the present disclosure will be described in detail below, but the present disclosure is not limited thereto, and may be implemented with appropriate modifications within the scope of the object of the present disclosure. In addition, although the overlapping description parts may be appropriately omitted, the gist of the present disclosure is not thus limited.

The range of each component in the glass and that in the glass product of the present disclosure will be described below. In the present specification, unless otherwise specified, the content of each component is expressed in terms of mole percent relative to a total amount of the glass substance converted to an oxide composition. Herein, “converted to an oxide composition” means that in the case that the oxides, composite salts, hydroxides, etc. used as the raw materials of the constituent components of the glass or the glass product of the present disclosure are decomposed and converted into oxides when they are melted, the total molar amount of the oxides is regarded as 100%.

Unless otherwise indicated under specific circumstances, the numerical ranges set forth herein include upper and lower limits, and the terms “or above” and “or below” include endpoint values, as well as all integers and fractions within the range, and are not limited to the specific values listed in the defined range. As used herein, “and/or” is inclusive. For example, “A and/or B” and means only A, or only B, or both A and B are present.

P₂O₅ is an indispensable component that constitutes the glass skeleton in the present disclosure, and it promotes the formation of the glass and contributes to the improvement on the chemical stability of the glass. When Cu²⁺ is contained, the glass having a phosphate system shows excellent near-infrared light absorbing property. If the content of P₂O₅ is less than 38%, the above effects are insufficient, and the near-infrared absorbing function of the glass does not meet the design requirements. Therefore, the lower limit of the content of P₂O₅ is 38%, preferably 40%, and more preferably 45%. If the content of P₂O₅ exceeds 65%, the devitrification tendency of the glass increases. Therefore, the upper limit of the content of P₂O₅ in the present disclosure is 65%, preferably 60%, and more preferably 55%.

Al₂O₃ is also a main component for forming the glass. It is used for enhancing the stability of the generated glass, increasing the intrinsic strength of the glass and improving the weather resistance of the glass. The present disclosure obtains the above properties by introducing 2% or more Al₂O₃. Preferably the lower limit of Al₂O₃ is 5%, and more preferably the lower limit thereof is 6%. When the content of Al₂O₃ exceeds 15%, the crystallization tendency of the glass increases and the melting property of the glass deteriorates. Thus, in the present disclosure, the upper limit of the content of Al₂O₃ is 15%, preferably 13%, and more preferably 11%.

CuO is an essential component for the glass of the present disclosure to obtain a near-infrared absorbing property. If the content of CuO is less than 8%, the near-infrared absorbing property of the glass may hardly meet the design requirements in the case that the glass is thinned and lightened. In some embodiments of the present disclosure, by introducing 10% or more CuO to participate in the formation of the glass network, the chemical stability of the glass may be improved, and the coefficient of thermal expansion may be reduced. Therefore, the lower limit of the content of CuO is 8%, preferably 10%, and more preferably 14%. If the content of CuO exceeds 25%, the visible light transmittance of the glass decreases, and the valence of Cu in the glass changes, so it becomes difficult to obtain the desired light absorbing property, and the glass would have low devitrification resistance. Therefore, in the present disclosure, the upper limit of the content of CuO is 25%, preferably 22%, and more preferably 20%.

Rn₂O (the content of Rn₂O is the total content of Li₂O, Na₂O, and K₂O) may lower the melting temperature and viscosity of the glass, and promote more Cu to exist in a state of Cu²⁺. However, as Rn₂O increases, the chemical stability of the glass deteriorates. In the present disclosure, the above properties are obtained by introducing 5% or more Rn₂O. The lower limit of Rn₂O is preferably 8%, and more preferably 10%. When the content of Rn₂O exceeds 40%, the devitrification resistance and transition temperature of the glass decrease, and the moldability of the glass deteriorates. Thus, in the present disclosure, the upper limit of the content of Rn₂O is 40%, preferably 30%, and more preferably 25%. Herein, “the content of Rn₂O is the total content of Li₂O, Na₂O, and K₂O” means that Rn₂O may represent a composition composed of any one of Li₂O, Na₂O, and K₂O; or any two of Li₂O, Na₂O, and K₂O; or all of Li₂O, Na₂O, and K₂O.

Li₂O exists as an essential component in the present disclosure to lower the melting temperature and viscosity of the glass, and to make the glass of the present disclosure suitable for chemical strengthening. Moreover, it makes a better contribution to the chemical stability and the mechanical strength than Na₂O and K₂O do. In the present disclosure, it is preferable to introduce 6% or more Li₂O. In some embodiments of the present disclosure, by introducing 10% or more Li₂O, it is possible to prevent a valence change and a reduction in devitrification resistance caused by the introduction of a large amount of CuO. However, when the content of Li₂O exceeds 30%, the chemical stability and moldability of the glass decrease. Therefore, the lower limit of the content of Li₂O is preferably 6%, more preferably 10%, and further preferably 12%; and the upper limit of the content of Li₂O is 30%, preferably 22%, and more preferably 20%.

As a result of extensive experimental research by the inventors, it is found that in the glass of the present disclosure, making the value of Li₂O/Rn₂O fall within the range of 0.4 to 1.0 may decrease the density of the glass and improve the devitrification resistance of the glass, and the value of Li₂O/Rn₂O is preferably 0.5 to 1.0; furthermore, by making the value of Li₂O/Rn₂O fall within the range of 0.7 to 1.0, the chemical strengthening properties of the glass may be further improved and the bending strength of the glass product may be enhanced, so the value of Li₂O/Rn₂O is more preferably 0.7 to 1.0, and further preferably 0.8 to 1.0.

In some embodiments of the present disclosure, by making the value of Li₂O/CuO be 0.3 or more, it is possible to prevent a valence change and a deterioration in devitrification resistance caused by the introduction of a large amount of CuO, and it is possible to improve the chemical stability of the glass; however, when the value of Li₂O/CuO exceeds 3.0, the high-temperature viscosity and transition temperature of the glass decrease, and the striae class of the glass deteriorates. Therefore, the value of Li₂O/CuO is 0.3 to 3.0, preferably 0.5 to 2.0, and more preferably 0.8 to 1.5.

In the present disclosure, by controlling the value of (Li₂O+CuO)/P₂O₅ to be within the range of 0.3 to 1.2, it is possible to improve the glass-forming stability and crystallization resistance of the glass, and it is possible to obtain a suitable degree of abrasion of the glass. Preferably, the value of (Li₂O+CuO)/P₂O₅ is 0.4 to 1.0, and more preferably, the value of (Li₂O+CuO)/P₂O₅ is 0.5 to 0.8.

Na₂O is a component for improving the melting property of the glass. In the present disclosure, by making the content of Na₂O be 10% or less, it is possible to improve the chemical stability of the glass while preventing a reduction in transition temperature. The content of Na₂O is preferably 5% or less, and more preferably 2% or less.

K₂O may increase the visible light transmittance of the glass, and when the content thereof exceeds 10%, the stability and chemical strengthening properties of the glass deteriorate. In some embodiments of the present disclosure, a 2% or less K₂O content may provide the glass with excellent crystallization resistance and chemical stability. Therefore, the content of K₂O is 10% or less, preferably 5% or less, and more preferably 2% or less.

In some embodiments of the present disclosure, by making the total content of Na₂O and K₂O, i.e., Na₂O+K₂O, be 10% or less, it is possible to endow the glass with a low melting temperature, as well as excellent stability and chemical strengthening properties. It is preferably that Na₂O+K₂O is 8% or less, and more preferably that Na₂O+K₂O is 5% or less.

In the present disclosure, the introduction of 1% or more RO (the content of RO is the total content of MgO, CaO, SrO, and BaO) may be useful for lowering the melting temperature of the glass, and improving the glass-forming stability and strength of the glass. Preferably, the lower limit of the content of RO is 2%, and more preferably, the lower limit is 4%. When the content of RO exceeds 30%, the crystallization resistance of the glass is reduced, and moreover, the chemical strengthening properties of the glass are lowered. Thus, the upper limit of the content of RO in the present disclosure is 30%, preferably 25%, and more preferably 20%. Herein, “the content of RO is the total content of MgO, CaO, SrO, and BaO” means that RO may represent a composition composed of any one of MgO, CaO, SrO, and BaO; or any two of MgO, CaO, SrO, and BaO; or any three of MgO, CaO, SrO, and BaO; or all of MgO, CaO, SrO, and BaO.

In the present disclosure, the introduction of 1% or more MgO may lower the melting temperature of the glass and improve the processability of the glass. Thus, the lower limit of the content of MgO is 1%, preferably 2%, and more preferably 4%. If the amount of the introduced MgO exceeds 15%, the crystallization resistance of the glass deteriorates, so the upper limit of the MgO content is 15%, preferably 12%, and more preferably 10%.

CaO is an optional component in the present disclosure. By introducing 8% or less CaO, it is possible to reduce the high-temperature viscosity while preventing the deterioration of the crystallization resistance. The CaO content is preferably 5% or less, and more preferably 3% or less.

SrO is an optional component in the present disclosure. By introducing 8% or less SrO, the chemical stability and crystallization resistance of the glass may be prevented from deterioration. The content of SrO is preferably 5% or less, and more preferably 3% or less.

BaO may increase the visible light transmittance of the glass, and improve the glass-forming stability and strength of the glass. If the content thereof exceeds 10%, the density of the glass increases. In some embodiments of the present disclosure, by making the content of BaO be 0.5% or more, the chemical stability of the glass may be improved, and the coefficient of thermal expansion of the glass may be reduced. Therefore, the content of BaO is 10% or less, preferably 0.5 to 8%, and more preferably 1 to 6%.

In some embodiments of the present disclosure, by making the value of BaO/MgO be 0.05 or more, it is possible to endow the glass with a lower coefficient of thermal expansion and excellent chemical stability, and the high-temperature viscosity of the glass may be improved; if the value of BaO/MgO exceeds 5.0, the density of the glass increases and the processability of the glass decreases. Therefore, the value of BaO/MgO is preferably 0.05 to 5.0, more preferably 0.1 to 3.0, and further preferably 0.15 to 1.0.

In some embodiments of the present disclosure, by making the value of RO/CuO be 2.0 or less, it is easier to obtain the desired transition temperature and hardness of the glass while a low coefficient of thermal expansion of the glass can be ensured. The value of RO/CuO is preferably 0.2 to 1.5, and more preferably 0.3 to 1.0.

In the present disclosure, a certain amount of V₂O₅ is introduced, which may promote the stable existence of CuO in the form of Cu′ in the glass, enhance the near-infrared light absorbing property of the glass, and improve the crystallization resistance and chemical strengthening properties of the glass. Moreover, If the content of V₂O₅ exceeds 3%, the visible light absorption of the glass is reinforced. Therefore, the content of V₂O₅ in the present disclosure is 0 to 3%, preferably 0.05 to 2%, and more preferably 0.1 to 1%.

As a result of extensive experimental research by the inventors, it is found that in some embodiments of the present disclosure, by controlling the ratio of the weight of 10 parts of V₂O₅ to that of 1 part of Li₂O, i.e., 10×V₂O₅/Li₂O, to be in the range of 0.02 to 3.0, the near-infrared light absorbing property of the glass may be improved, and decrease in visible light transmittance of the glass may be suppressed. Therefore, the value of 10×V₂O₅/Li₂O is 0.02 to 3.0, and preferably 0.05 to 2.0. Furthermore, by controlling 10×V₂O₅/Li₂O to be 0.1 to 0.8, the devitrification resistance and chemical strengthening properties of the glass may be enhanced, and the strength of the glass may be improved. Thus, it is more preferably that 10×V₂O₅/Li₂O is 0.1 to 0.8.

In some embodiments of the present disclosure, in order to endow the glass with excellent devitrification resistance and melting property, and improve the processability of the glass, while making the glass have a low coefficient of thermal expansion, it is preferable to control the value of (Li₂O+BaO+CuO)/(Na₂O+K₂O+MgO+CaO+SrO) to be within a range of 2.0 to 17.0; more preferably, the value of (Li₂O+BaO+CuO)/(Na₂O+K₂O+MgO+CaO+SrO) is 3.0 to 12.0, and further preferably, the value of (Li₂O+BaO+CuO)/(Na₂O+K₂O+MgO+CaO+SrO) is 4.0 to 10.0.

The present disclosure may reduce the melting temperature of the glass by introducing a proper amount of B₂O₃. When the content of B₂O₃ exceeds 10%, the near-infrared light absorbing characteristic is reduced. Therefore, the content of B₂O₃ is 0 to 10%, preferably 0 to 5%, and more preferably 0 to 2%; and it is further preferred that B₂O₃ is not introduced.

The addition of a suitable amount of SiO₂ into the glass may promote the formation of the glass and improve the chemical stability of the glass. When the content of SiO₂ exceeds 10%, the melting property of the glass deteriorates, and thus unmelted impurities are likely to be formed in the glass, and moreover, the near-infrared absorbing characteristic of the glass are likely to deteriorate. Therefore, the content of SiO₂ is 0 to 10%, preferably 0 to 5%, and more preferably 0 to 2%; and it is further preferred that SiO₂ is not introduced.

The addition of a small amount of ZrO₂ into the glass may improve the crystallization resistance of the glass while enhancing the chemical stability of the glass. However, if the content of ZrO₂ exceeds 10%, the melting property of the glass may be significantly reduced and the high-temperature viscosity of the glass may be remarkably increased, so that unmelted substances are likely to be formed in the glass. Therefore, the content of ZrO₂ is limited to 0 to 10%, preferably 0 to 5%, and more preferably 0 to 2%; and it is further preferred that ZrO₂ is not introduced.

ZnO may reduce the transition temperature of the glass and improve the melting property of the glass. When the content of ZnO exceeds 8%, the transition temperature of the glass does not meet the design requirements, and the chemical stability tends to be reduced. Therefore, the content of ZnO is 0 to 8%, preferably 0 to 5%, and more preferably 0 to 2%; and it is further preferred that ZnO is not introduced.

Ln₂O₃ (Ln₂O₃ is one or more of La₂O₃, Gd₂O₃, Y₂O₃, and Yb₂O₃) may increase the refractive index of the glass and maintain low dispersibility. However, when the content of Ln₂O₃ exceeds 10%, the melting temperature of the glass is increased and the chemical stability is reduced. Therefore, the content of Ln₂O₃ is 0 to 10%, preferably 0 to 5%, and more preferably 0 to 2%.

The refining effect on the glass may be improved by introducing 0 to 1% one or more components of Sb₂O₃, SnO₂, SnO, and CeO₂ as a refining agent, and it is preferable to introduce 0 to 0.5% the refining agent. Since the class of bubble in the glass of the present disclosure is good, it is further preferred that a refining agent is not introduced.

F can lower the melting temperature of the glass, but the introduction thereof may result in volatilization during the melting of the glass, which causes environmental pollution and easy formation of striae in the glass. Thus, the content of F is preferably 5% or less, and more preferably 2% or less; and it is further preferred that F is not introduced.

In some embodiments, the addition of a small amount of Fe may improve the near-infrared light absorbing property of the glass. Fe may be present as FeO and Fe₂O₃, and preferably FeO. The upper limit of Fe content is 5%, and preferably 2%. If the content of Fe is high, crystals are easily formed in the glass and the visible light transmittance is drastically reduced. In some embodiments, even a small amount of Fe may cause deterioration in crystallization resistance of the glass, and thus it is further preferred that Fe is not introduced.

The terms “not introduced”, “not comprising”, “0%” as used herein means that mentioned compounds, molecules or elements are not intentionally added as raw materials into the glass or the glass product of the present disclosure; however, certain impurities or components not intentionally added may be present in the raw materials and/or equipment for producing the glass or the glass product, and may be present in small or trace amounts in the final glass or glass product. Such a situation also falls within the scope of patent protection to be claimed by the present disclosure.

[Preparation Method]

The method for preparing the glass of the present disclosure is as follows. The glass of the present disclosure is produced by adopting conventional raw materials and conventional processes: carbonate, nitrate, phosphate, metaphosphate, sulfate, hydroxide, oxide and the like are used as raw materials; after the raw materials are mixed according to a conventional method, the prepared furnace burden is put into a melting furnace at 1,000 to 1,200° C. for melting; after refining, stirring and homogenizing, a homogeneous molten glass without bubbles and undissolved substances is obtained; and the molten glass is cast in a mold and annealed. Those skilled in the art can appropriately select the raw materials, the process method and the process parameters according to the actual needs.

The glass of the present disclosure may be molded by well-known methods. In some embodiments, the glass described herein may be fabricated, by various processes, into formed bodies, including but not limited to sheets. Those processes include but are not limited to slit down drawing, floating, rolling, and other sheet-forming processes known in the art. Alternatively, the glass may be formed by a float process or a rolling process as is known in the art.

The glass of the present disclosure may be prepared into a sheet glass formed body by adopting grinding, polishing processing, or other methods, but the methods for preparing the glass formed body are not limited thereto.

The glass according to the present disclosure may have any thickness that is reasonable and useful.

The glass of the present disclosure may obtain higher strength by forming a compressive stress layer (e.g., chemical strengthening), and then be prepared into glass products.

In some embodiments, the glass may be processed into sheets, and then chemically strengthened through a chemical strengthening process.

The chemical strengthening methods according to the present disclosure include an ion exchange method. The glass of the present disclosure may be subjected to ion exchange by a method generally known in the art. In the process of ion exchange, smaller metal ions in the glass are replaced with or “exchanged” for larger metal ions of the same valence which close to the glass. Replacing smaller ions with larger ions builds up compressive stress in the glass to form a compressive stress layer.

In some embodiments, the metal ions are monovalent alkali metal ions (e.g., Na⁺, K⁺, Rb⁺, Cs⁺, etc.), and the ion exchange is performed by immersing the glass in a salt bath containing at least one molten salt having larger metal ions, wherein the larger metal ions are used to replace the smaller metal ions in the glass. Alternatively, other monovalent metal ions such as Ag⁺, Tl⁺, Cu⁺, etc. may also be used to exchange for monovalent ions. One or more ion exchange processes used to chemically strengthen the glass may include, but are not limited to: immersing the glass in a single salt bath, or immersing it in multiple salt baths having the same or different compositions, wherein there are washing and/or annealing steps between each immersion.

In some embodiments, the glass may be subjected to ion exchange by immersing it in a salt bath of molten Na salt (such as NaNO₃) at a temperature of about 230° C. to 300° C. for about 0.5 to 5 hours; the preferred temperature range is 250° C. to 280° C., and the preferred time range is 1 to 4 hours. In such embodiments, the Na ions replace part of the Li ions in the glass, thereby forming a surface compressive layer and exhibiting high mechanical properties. In some embodiments, the glass may be subjected to ion exchange by immersing it in a salt bath of molten K salt (such as KNO₃) at a temperature of about 230° C. to 300° C. for about 0.5 to 5 hours.

In some embodiments, the glass may be subjected to ion exchange by immersing it in a salt bath of mixed salt in which Na salt and K salt (e.g., NaNO₃+KNO₃) are mixed in a certain ratio at a temperature of about 230° C. to 300° C. for about 0.5 to 5 hours; the preferred temperature range is 250° C. to 280° C., and the preferred time range is 1 to 4 hours. The ratio of Na salt to K salt may be 1:(1 to 9). In such embodiments, the Na ions or the K ions replace part of the Li ions in the glass, thereby forming a surface compressive layer and exhibiting high mechanical properties.

In some embodiments, the chemical strengthening methods of the present disclosure further include a chemical etching method. The glass is placed in an etching solution formed from NaOH and/or KOH solution at a certain temperature and a certain concentration for chemical etching, and the mechanical properties of the glass are enhanced by passivation of the remaining micro-cracks in the glass processing. The concentration of the etching solution is preferably 3 to 40%, more preferably 5 to 30%, and further preferably 5 to 20%; the etching temperature is preferably 50 to 150° C., more preferably 60 to 120° C., and further preferably 70 to 110° C.; and the chemical etching time is preferably 1 to 60 minutes, more preferably 1 to 40 minutes, and further preferably 2 to 30 minutes.

In some embodiments, there are also an ion implantation method in which ions are implanted into the surface layer of the glass, and a thermal tempering method in which the glass is heated and then rapidly cooled.

The properties of the glass or the glass product of the present disclosure will be described below.

<Transition Temperature>

The transition temperature (T_{g}) of the glass or the glass product was tested according to the method specified in GB/T7962.16-2010.

The glass or the glass product of the present disclosure has a transition temperature (T_{g}) of 405° C. or higher, preferably 410° C. or higher, and more preferably 415 to 450° C.

<Upper Limit Temperature of Crystallization>

The crystallization property of the glass or the glass product was measured by a temperature gradient furnace method. The glass or the glass product was prepared into a sample of 180*10*10 mm, the sides of which were polished; the sample was placed in a furnace with a temperature gradient (5° C./cm) and heated to 1400° C.; the temperature was kept for 4 hours; thereafter, the sample was taken out and naturally cooled to room temperature. The crystallization of the glass or the glass product was observed under a microscope. The highest temperature corresponding to the appearance of crystals in the glass or the glass product was the upper limit temperature of crystallization of the glass or the glass product.

The upper limit temperature of crystallization of the glass or the glass product of the present disclosure is 1050° C. or lower, preferably 1040° C. or lower, and more preferably 1030° C. or lower.

<Density>

The density (φ of the glass or the glass product was tested according to the method specified in GB/T7962.20-2010.

The density (p) of the glass or glass product of the present disclosure is 3.1 g/cm³ or less, preferably 3.0 g/cm³ or less, and more preferably 2.9 g/cm³ or less.

<Coefficient of Thermal Expansion>

The coefficient of thermal expansion (α_{20-120° C.}) of the glass or the glass product was tested according to the method specified in GB/T7962.16-2010.

The coefficient of thermal expansion (α_{20-120° C.}) of the glass or the glass product of the present disclosure is 98×10⁻⁷/K or less, preferably 93×10⁻⁷/K or less, and more preferably 90×10⁻⁷/K or less.

<Spectral Transmittance>

The spectral transmittance of the glass or the glass product of the present disclosure refers to a value obtained by a spectrophotometer in the stated manner: it is assumed that the glass or the glass product sample has two planes parallel to each other and optically polished, and light perpendicularly enters one plane and exits the other plane parallel to the first plane; the intensity of the exiting light divided by the intensity of the incident light is the transmittance, which is also called external transmittance.

When the thickness of the glass or the glass product is 0.11 mm, the spectral transmittance has the following characteristics:

The spectral transmittance at a wavelength of 400 nm is 73% or more, preferably 76% or more, and more preferably 78% or more.

The spectral transmittance at a wavelength of 1,100 nm is 15% or less, preferably 13% or less, and more preferably 10% or less.

When the thickness of the glass or the glass product is 0.11 mm, the wavelength at which the spectral transmittance reaches 50% (λ₅₀) is in the range of 622 to 650 nm, preferably in the range of 628 to 645 nm, and more preferably in the range of 630 to 640 nm.

<Bending Strength>

The bending strength of the glass product of the present disclosure is suitable for being tested by adopting a three-point method at room temperature with a microcomputer-controlled electronic universal testing machine (model: CMT 6502). The three-point bending strength test refers to a process as follows: the sample was placed on two support points having a certain distance therebetween, and load was placed on one point which is in the middle of the line between the support points; and the maximum bending stress at the break of the sample was measured.

Calculation of Bending Strength:

Three-point bending strength:

$${σ}_{( 3 , L )} = \frac{3 L \times F}{2 {Wt}^{2}}$$

In the formula, σ_{(3,L)}: the three-point bending strength (MPa);

L: the span between the lower two support points (mm);

F: the maximum bending stress when the sample breaks (N);

W: the width of the sample (mm); and

t: the thickness of the sample (mm).

The glass product of the present disclosure was made to have the following dimensions: 50 mm*20 mm*0.11 mm (length*width*thickness). And the test conditions were as follows: the diameter of the indenter was 06 mm; the pressing speed was 1 mm/min; and the span was 30 mm.

The bending strength (a) of the glass product is 400 MPa or more, preferably 450 MPa or more, more preferably 500 MPa or more, and further preferably 520 to 700 MPa.

[Glass Element]

The glass element involved in the present disclosure contains the above-mentioned glass or glass product, and examples thereof include sheet-like glass elements used in near-infrared light absorbing optical filters, and lenses. The glass element is suitable for color correction purposes of solid-state imaging elements, and has the various excellent properties of the above-mentioned glass or glass product.

Moreover, the thickness of the glass element (the interval between the plane where the transmitted light enters and the plane where the transmitted light exits) is determined by the transmittance characteristics of the element. The thickness is preferably between 0.05 and 0.5 mm, more preferably between 0.08 and 0.3 mm, and further preferably between 0.1 and 0.2 mm. The wavelength at which the spectral transmittance reaches 50% (λ₅₀) is in the range of 622 to 650 nm, preferably in the range of 628 to 645 nm, and more preferably in the range of 630 to 640 nm. In order to obtain such a glass element, the composition of the glass is adjusted and the glass is processed into an element with a thickness having the above-mentioned spectral characteristics.

[Optical Filter]

The optical filter involved in the present disclosure is a near-infrared optical filter, which contains the above-mentioned glass or glass product, or contains a glass element comprising the above-mentioned glass or glass product. The optical filter has a color correction function, and also has the various excellent properties of the above-mentioned glass or glass product.

[Device]

The glass or the glass product, or the glass element, or the optical filter of the present disclosure may be used, by well-known methods, to manufacture devices such as portable communication devices (e.g., mobile phones), smart wearable devices, photographic devices, camera devices, display devices, and monitoring devices.

### EXAMPLES

### Examples of Glass and Glass Products

In order to further clearly explain and illustrate the technical solutions of the present disclosure, the following non-limiting examples are provided.

In these Examples, the pieces of glass having the compositions shown in Table 1 to Table 3 were obtained by adopting the above-mentioned method for preparing glass. In addition, the characteristics of each piece of glass were measured by the test methods described in the present disclosure. And the measurement results are shown in Table 1 to Table 3, where K₁ represents Li₂O/Rn₂O, K₂ represents BaO/MgO, K₃ represents Li₂O/CuO, K₄ represents Na₂O+K₂O, K₅ represents (Li₂O+CuO)/P₂O₅, K₆ represents 10×V₂O₅/Li₂O, K₇ represents RO/CuO, and K₈ represents (Li₂O+BaO+CuO)/(Na₂O+K₂O+MgO+CaO+SrO).

TABLE 1

| Components | 1 | 2 | 3 | 4 | 5 | 6 | 7 | 8 | 9 | 10 |
|---|---|---|---|---|---|---|---|---|---|---|
| P₂O₅ | 54.30 | 52.40 | 48.30 | 43.23 | 56.25 | 43.26 | 40.70 | 58.20 | 61.37 | 55.20 |
| Al₂O₃ | 5.24 | 10.34 | 12.27 | 14.10 | 6.34 | 4.55 | 8.15 | 7.20 | 3.30 | 9.25 |
| Li₂O | 21.4 | 10.25 | 9.35 | 13.40 | 15.70 | 19.34 | 28.20 | 13.35 | 15.20 | 18.50 |
| Na₂O | 0.50 | 0 | 0 | 0 | 0 | 0.24 | 0 | 2.95 | 0 | 0 |
| K₂O | 0 | 0 | 0.18 | 0 | 0 | 0 | 0 | 0 | 0 | 0 |
| MgO | 4.21 | 6.34 | 11.20 | 2.35 | 5.36 | 7.44 | 3.57 | 5.26 | 5.16 | 2.30 |
| CaO | 0 | 0 | 1.10 | 0 | 0 | 0 | 0 | 0 | 0 | 0 |
| SrO | 0 | 0 | 0 | 0 | 0 | 0 | 0 | 0 | 0 | 0 |
| BaO | 1.20 | 0.65 | 2.25 | 5.33 | 2.47 | 3.60 | 1.58 | 2.45 | 1.48 | 0.85 |
| CuO | 12.90 | 18.46 | 14.00 | 21.20 | 13.33 | 20.00 | 15.60 | 9.35 | 12.66 | 13.65 |
| V₂O₅ | 0.25 | 0.36 | 0.75 | 0.18 | 0.55 | 1.57 | 2.20 | 1.24 | 0.83 | 0.25 |
| SiO₂ | 0 | 1.20 | 0 | 0 | 0 | 0 | 0 | 0 | 0 | 0 |
| B₂O₃ | 0 | 0 | 0 | 0 | 0 | 0 | 0 | 0 | 0 | 0 |
| ZnO | 0 | 0 | 0 | 0 | 0 | 0 | 0 | 0 | 0 | 0 |
| ZrO₂ | 0 | 0 | 0 | 0.21 | 0 | 0 | 0 | 0 | 0 | 0 |
| La₂O₃ | 0 | 0 | 0.50 | 0 | 0 | 0 | 0 | 0 | 0 | 0 |
| Gd₂O₃ | 0 | 0 | 0 | 0 | 0 | 0 | 0 | 0 | 0 | 0 |
| Y₂O₃ | 0 | 0 | 0 | 0 | 0 | 0 | 0 | 0 | 0 | 0 |
| Yb₂O₃ | 0 | 0 | 0 | 0 | 0 | 0 | 0 | 0 | 0 | 0 |
| Sb₂O₃ | 0 | 0 | 0 | 0 | 0 | 0 | 0 | 0 | 0 | 0 |
| CeO₂ | 0 | 0 | 0.10 | 0 | 0 | 0 | 0 | 0 | 0 | 0 |
| SnO₂ | 0 | 0 | 0 | 0 | 0 | 0 | 0 | 0 | 0 | 0 |
| SnO | 0 | 0 | 0 | 0 | 0 | 0 | 0 | 0 | 0 | 0 |
| Total | 100.00 | 100.00 | 100.00 | 100.00 | 100.00 | 100.00 | 100.00 | 100.00 | 100.00 | 100.00 |
| Rn₂O | 21.90 | 10.25 | 9.53 | 13.40 | 15.70 | 19.58 | 28.20 | 16.30 | 15.20 | 18.50 |
| RO | 5.41 | 6.99 | 14.55 | 7.68 | 7.83 | 11.04 | 5.15 | 7.71 | 6.64 | 3.15 |
| K1 | 0.977 | 1 | 0.981 | 1 | 1 | 0.988 | 1 | 0.819 | 1 | 1 |
| K2 | 0.285 | 0.103 | 0.201 | 2.268 | 0.461 | 0.484 | 0.443 | 0.466 | 0.287 | 0.37 |
| K3 | 1.659 | 0.555 | 0.668 | 0.632 | 1.178 | 0.967 | 1.808 | 1.428 | 1.201 | 1.355 |
| K4 | 0.50 | 0 | 0.18 | 0 | 0 | 0.24 | 0 | 2.95 | 0 | 0 |
| K5 | 0.632 | 0.548 | 0.483 | 0.8 | 0.516 | 0.909 | 1.076 | 0.39 | 0.454 | 0.582 |
| K6 | 0.117 | 0.351 | 0.802 | 0.134 | 0.35 | 0.812 | 0.78 | 0.929 | 0.546 | 0.135 |
| K7 | 0.419 | 0.379 | 1.039 | 0.362 | 0.587 | 0.552 | 0.33 | 0.825 | 0.524 | 0.231 |
| K8 | 7.537 | 4.631 | 2.051 | 16.99 | 5.877 | 5.591 | 12.71 | 3.063 | 5.686 | 14.35 |
| Upper Limit | 1015 | 1010 | 1010 | 1005 | 1005 | 1010 | 1010 | 1020 | 1015 | 1010 |
| Temperature of | | | | | | | | | | |
| Crystallization (° C.) | | | | | | | | | | |
| T_{g} (° C.) | 416 | 427 | 435 | 426 | 424 | 420 | 410 | 422 | 427 | 425 |
| ρ (g/cm³) | 2.81 | 2.80 | 2.84 | 2.93 | 2.78 | 2.81 | 2.79 | 2.81 | 2.77 | 2.76 |
| α_{20-120° C.} (×10⁻⁷/K) | 87 | 92 | 88 | 83 | 87 | 85 | 84 | 86 | 87 | 85 |

TABLE 2

| Components | 11 | 12 | 13 | 14 | 15 | 16 | 17 | 18 | 19 | 20 |
|---|---|---|---|---|---|---|---|---|---|---|
| P₂O₅ | 47.63 | 50.24 | 49.37 | 52.50 | 48.31 | 50.70 | 54.60 | 42.15 | 44.20 | 51.34 |
| Al₂O₃ | 7.30 | 5.46 | 6.25 | 6.49 | 8.35 | 6.30 | 7.51 | 4.25 | 3.38 | 9.25 |
| Li₂O | 16.90 | 12.21 | 10.16 | 7.34 | 15.60 | 15.27 | 8.57 | 20.19 | 23.02 | 12.00 |
| Na₂O | 0 | 3.52 | 0 | 5.73 | 0 | 4.12 | 0 | 0 | 0 | 1.42 |
| K₂O | 0 | 1.26 | 0 | 0 | 2.28 | 0 | 0 | 0 | 0 | 0.50 |
| MgO | 6.37 | 7.42 | 1.34 | 5.57 | 4.66 | 7.20 | 6.38 | 7.54 | 8.28 | 6.34 |
| CaO | 0 | 0 | 2.50 | 0 | 0 | 0 | 0 | 1.60 | 0 | 2.20 |
| SrO | 0 | 0 | 0 | 1.00 | 0.5 | 0 | 0 | 0 | 0 | 0 |
| BaO | 3.65 | 7.40 | 4.52 | 8.50 | 2.65 | 1.74 | 3.35 | 2.57 | 4.58 | 1.60 |
| CuO | 16.30 | 10.50 | 23.20 | 12.30 | 15.50 | 13.42 | 18.50 | 20.24 | 16.34 | 14.02 |
| V₂O₅ | 0.35 | 0.74 | 0.66 | 0.57 | 0.85 | 1.25 | 0.34 | 1.46 | 0.15 | 0.78 |
| SiO₂ | 0 | 1.25 | 0 | 0 | 0 | 0 | 0 | 0 | 0 | 0.55 |
| B₂O₃ | 0 | 0 | 0 | 0 | 0 | 0 | 0 | 0 | 0 | 0 |
| ZnO | 0 | 0 | 0 | 0 | 0 | 0 | 0 | 0 | 0 | 0 |
| ZrO₂ | 1.50 | 0 | 0 | 0 | 0 | 0 | 0 | 0 | 0 | 0 |
| La₂O₃ | 0 | 0 | 0 | 0 | 1.30 | 0 | 0 | 0 | 0 | 0 |
| Gd₂O₃ | 0 | 0 | 2.00 | 0 | 0 | 0 | 0 | 0 | 0 | 0 |
| Y₂O₃ | 0 | 0 | 0 | 0 | 0 | 0 | 0.75 | 0 | 0 | 0 |
| Yb₂O₃ | 0 | 0 | 0 | 0 | 0 | 0 | 0 | 0 | 0 | 0 |
| Sb₂O₃ | 0 | 0 | 0 | 0 | 0 | 0 | 0 | 0 | 0.05 | 0 |
| CeO₂ | 0 | 0 | 0 | 0 | 0 | 0 | 0 | 0 | 0 | 0 |
| SnO₂ | 0 | 0 | 0 | 0 | 0 | 0 | 0 | 0 | 0 | 0 |
| SnO | 0 | 0 | 0 | 0 | 0 | 0 | 0 | 0 | 0 | 0 |
| Total | 100.00 | 100.00 | 100.00 | 100.00 | 100.00 | 100.00 | 100.00 | 100.00 | 100.00 | 100.00 |
| Rn₂O | 16.90 | 16.99 | 10.16 | 13.07 | 17.88 | 19.39 | 8.57 | 20.19 | 23.02 | 13.92 |
| RO | 10.02 | 14.82 | 8.36 | 15.07 | 7.81 | 8.94 | 9.73 | 11.71 | 12.86 | 10.14 |
| K1 | 1 | 0.719 | 1 | 0.562 | 0.872 | 0.788 | 1 | 1 | 1 | 0.862 |
| K2 | 0.573 | 0.997 | 3.373 | 1.526 | 0.569 | 0.242 | 0.525 | 0.341 | 0.553 | 0.252 |
| K3 | 1.037 | 1.163 | 0.438 | 0.597 | 1.006 | 1.138 | 0.463 | 0.998 | 1.409 | 0.856 |
| K4 | 0 | 4.78 | 0 | 5.73 | 2.28 | 4.12 | 0 | 0 | 0 | 1.92 |
| K5 | 0.697 | 0.452 | 0.676 | 0.374 | 0.644 | 0.566 | 0.496 | 0.959 | 0.89 | 0.507 |
| K6 | 0.207 | 0.606 | 0.65 | 0.777 | 0.545 | 0.819 | 0.397 | 0.723 | 0.065 | 0.65 |
| K7 | 0.615 | 1.411 | 0.36 | 1.225 | 0.504 | 0.666 | 0.526 | 0.579 | 0.787 | 0.723 |
| K8 | 5.785 | 2.468 | 9.865 | 2.288 | 4.536 | 2.688 | 4.768 | 4.705 | 5.307 | 2.641 |
| Upper Limit | 1010 | 1025 | 1005 | 1035 | 1000 | 1025 | 1020 | 1015 | 1010 | 1020 |
| Temperature of | | | | | | | | | | |
| Crystallization (° C.) | | | | | | | | | | |
| T_{g} (° C.) | 421 | 422 | 425 | 426 | 427 | 420 | 428 | 418 | 413 | 427 |
| ρ (g/cm³) | 2.85 | 2.83 | 2.95 | 2.90 | 2.84 | 2.81 | 2.80 | 2.77 | 2.81 | 2.82 |
| α_{20-120° C.} (×10⁻⁷/K) | 86 | 91 | 78 | 88 | 87 | 85 | 84 | 84 | 86 | 83 |

TABLE 3

| Components | 21 | 22 | 23 | 24 | 25 | 26 | 27 | 28 | 29 | 30 |
|---|---|---|---|---|---|---|---|---|---|---|
| P₂O₅ | 46.38 | 50.52 | 49.37 | 52.34 | 51.60 | 54.20 | 50.27 | 51.44 | 48.70 | 49.35 |
| Al₂O₃ | 8.24 | 7.52 | 7.66 | 6.47 | 8.15 | 9.34 | 8.24 | 7.49 | 9.10 | 10.20 |
| Li₂O | 16.34 | 17.24 | 15.24 | 13.37 | 18.50 | 16.34 | 18.24 | 19.22 | 20.25 | 17.40 |
| Na₂O | 0 | 2.50 | 0 | 0 | 1.15 | 0 | 0 | 0 | 0 | 0 |
| K₂O | 1.50 | 0 | 0 | 0 | 0 | 0 | 0.70 | 0 | 0 | 0 |
| MgO | 7.52 | 6.34 | 7.15 | 8.75 | 6.33 | 4.15 | 5.50 | 6.34 | 4.75 | 3.27 |
| CaO | 0.35 | 0 | 0 | 0 | 0 | 0 | 0 | 1.15 | 0 | 0 |
| SrO | 0 | 0 | 0 | 0 | 0 | 0.50 | 0 | 0.25 | 0 | 0 |
| BaO | 2.15 | 1.67 | 3.20 | 2.17 | 1.45 | 2.24 | 2.15 | 1.67 | 1.46 | 0.80 |
| CuO | 16.82 | 13.69 | 16.78 | 16.53 | 12.17 | 12.88 | 14.66 | 11.94 | 15.49 | 16.48 |
| V₂O₅ | 0.70 | 0.52 | 0.60 | 0.37 | 0.65 | 0.35 | 0.24 | 0.50 | 0.25 | 2.50 |
| SiO₂ | 0 | 0 | 0 | 0 | 0 | 0 | 0 | 0 | 0 | 0 |
| B₂O₃ | 0 | 0 | 0 | 0 | 0 | 0 | 0 | 0 | 0 | 0 |
| ZnO | 0 | 0 | 0 | 0 | 0 | 0 | 0 | 0 | 0 | 0 |
| ZrO₂ | 0 | 0 | 0 | 0 | 0 | 0 | 0 | 0 | 0 | 0 |
| La₂O₃ | 0 | 0 | 0 | 0 | 0 | 0 | 0 | 0 | 0 | 0 |
| Gd₂O₃ | 0 | 0 | 0 | 0 | 0 | 0 | 0 | 0 | 0 | 0 |
| Y₂O₃ | 0 | 0 | 0 | 0 | 0 | 0 | 0 | 0 | 0 | 0 |
| Yb₂O₃ | 0 | 0 | 0 | 0 | 0 | 0 | 0 | 0 | 0 | 0 |
| Sb₂O₃ | 0 | 0 | 0 | 0 | 0 | 0 | 0 | 0 | 0 | 0 |
| CeO₂ | 0 | 0 | 0 | 0 | 0 | 0 | 0 | 0 | 0 | 0 |
| SnO₂ | 0 | 0 | 0 | 0 | 0 | 0 | 0 | 0 | 0 | 0 |
| SnO | 0 | 0 | 0 | 0 | 0 | 0 | 0 | 0 | 0 | 0 |
| Total | 100.00 | 100.00 | 100.00 | 100.00 | 100.00 | 100.00 | 100.00 | 100.00 | 100.00 | 100.00 |
| Rn₂O | 17.84 | 19.74 | 15.24 | 13.37 | 19.65 | 16.34 | 18.94 | 19.22 | 20.25 | 17.40 |
| RO | 10.02 | 8.01 | 10.35 | 10.92 | 7.78 | 6.89 | 7.65 | 9.41 | 6.21 | 4.07 |
| K1 | 0.916 | 0.873 | 1 | 1 | 0.941 | 1 | 0.963 | 1 | 1 | 1 |
| K2 | 0.286 | 0.263 | 0.448 | 0.248 | 0.229 | 0.54 | 0.391 | 0.263 | 0.307 | 0.245 |
| K3 | 0.971 | 1.259 | 0.908 | 0.809 | 1.52 | 1.269 | 1.244 | 1.61 | 1.307 | 1.056 |
| K4 | 1.50 | 2.50 | 0 | 0 | 1.15 | 0 | 0.70 | 0 | 0 | 0 |
| K5 | 0.715 | 0.612 | 0.649 | 0.571 | 0.594 | 0.539 | 0.654 | 0.606 | 0.734 | 0.687 |
| K6 | 0.428 | 0.302 | 0.394 | 0.277 | 0.351 | 0.214 | 0.132 | 0.26 | 0.123 | 1.437 |
| K7 | 0.596 | 0.585 | 0.617 | 0.661 | 0.639 | 0.535 | 0.522 | 0.788 | 0.401 | 0.247 |
| K8 | 3.768 | 3.688 | 4.926 | 3.665 | 4.294 | 6.766 | 5.653 | 4.242 | 7.832 | 10.61 |
| Upper Limit | 1015 | 1015 | 1010 | 1005 | 1015 | 1010 | 1020 | 1000 | 1005 | 1010 |
| Temperature of | | | | | | | | | | |
| Crystallization (° C.) | | | | | | | | | | |
| T_{g} (° C.) | 426 | 422 | 427 | 432 | 423 | 425 | 427 | 426 | 425 | 422 |
| ρ (g/cm³) | 2.80 | 2.78 | 2.81 | 2.83 | 2.76 | 2.77 | 2.82 | 2.81 | 2.80 | 2.84 |
| α_{20-120° C.} (×10⁻⁷/K) | 86 | 87 | 87 | 85 | 86 | 84 | 85 | 87 | 85 | 84 |

The pieces of glass prepared in the Examples described in Table 1 to Table 3 above were processed into 0.11 mm-thick glass sheets, and the spectral transmittance of the glass in each Example was measured according to the test method described above. The results are shown in Table 4 to Table 6.

TABLE 4

| Examples | 1 | 2 | 3 | 4 | 5 | 6 | 7 | 8 | 9 | 10 |
|---|---|---|---|---|---|---|---|---|---|---|
| λ₅₀ (nm) | 630 | 631 | 628 | 625 | 633 | 635 | 632 | 634 | 630 | 633 |
| τ₄₀₀ (%) | 75.5 | 78.2 | 77.5 | 79.3 | 78.8 | 79.2 | 77.4 | 77.0 | 76.4 | 80.2 |
| τ_{1,100} (%) | 11.4 | 10.3 | 9.7 | 9.2 | 9.5 | 8.8 | 10.0 | 10.2 | 9.8 | 8.5 |

TABLE 5

| Examples | 11 | 12 | 13 | 14 | 15 | 16 | 17 | 18 | 19 | 20 |
|---|---|---|---|---|---|---|---|---|---|---|
| λ₅₀ (nm) | 632 | 631 | 634 | 635 | 635 | 629 | 630 | 627 | 630 | 635 |
| τ₄₀₀ (%) | 78.5 | 81.4 | 82.2 | 80.3 | 79.4 | 77.2 | 78.5 | 85.0 | 81.4 | 78.2 |
| τ_{1,100} (%) | 9.3 | 8.7 | 8.2 | 9.1 | 10.0 | 10.2 | 9.5 | 8.3 | 8.6 | 9.7 |

TABLE 6

| Examples | 21 | 22 | 23 | 24 | 25 | 26 | 27 | 28 | 29 | 30 |
|---|---|---|---|---|---|---|---|---|---|---|
| λ₅₀ (nm) | 632 | 631 | 632 | 633 | 632 | 632 | 634 | 633 | 634 | 632 |
| τ₄₀₀ (%) | 78.2 | 77.6 | 79.3 | 80.5 | 78.5 | 82.2 | 78.4 | 79.0 | 78.8 | 81.1 |
| τ_{1,100} (%) | 9.5 | 9.6 | 9.4 | 8.8 | 9.4 | 8.6 | 9.8 | 9.2 | 9.4 | 9.0 |

The Examples of glass described in Table 4 to Table 6 above were chemically strengthened according to the above-mentioned chemical strengthening methods to form glass products, and the bending strength of each glass product was tested according to the above-mentioned bending strength test method. The results are shown in Table 7 to Table 9 below.

TABLE 7

| Examples | 1 | 2 | 3 | 4 | 5 | 6 | 7 | 8 | 9 | 10 |
|---|---|---|---|---|---|---|---|---|---|---|
| σ (MPa) | 525 | 527 | 510 | 530 | 524 | 550 | 548 | 516 | 536 | 530 |

TABLE 8

| Examples | 11 | 12 | 13 | 14 | 15 | 16 | 17 | 18 | 19 | 20 |
|---|---|---|---|---|---|---|---|---|---|---|
| σ (MPa) | 545 | 570 | 562 | 505 | 550 | 517 | 554 | 542 | 518 | 560 |

TABLE 9

| Examples | 21 | 22 | 23 | 24 | 25 | 26 | 27 | 28 | 29 | 30 |
|---|---|---|---|---|---|---|---|---|---|---|
| σ (MPa) | 534 | 550 | 545 | 540 | 550 | 552 | 547 | 546 | 558 | 560 |

### Examples of Glass Elements

The pieces of glass and/or the glass products in the above-mentioned Examples 1 to 30 were prepared into glass elements by methods known in the art. Examples include sheet-like glass elements used in near-infrared light absorbing optical filters, and lenses. Those glass elements were suitable for color correction purposes of solid-state imaging elements, and had the various excellent properties of the above-mentioned glass or glass product.

### Examples of Optical Filters

The pieces of glass, and/or the glass products, and/or the glass elements in the above-mentioned Examples 1 to 30 were prepared into optical filters by methods known in the art. The optical filters of the present disclosure had a color correction function, and also had the various excellent properties of the above-mentioned glass or glass product.

### Examples of Devices

The pieces of glass, and/or the glass products, and/or the glass elements, and/or the optical filters of the present disclosure might be used, by well-known methods, to manufacture devices such as portable communication devices (e.g., mobile phones), smart wearable devices, photographic devices, camera devices, display devices, and monitoring devices. They might also be used in, for example, imaging devices, sensors, microscopes, medical technology, digital projection, optical communication technology/information transmission, or camera devices and apparatus in the field of vehicle on-board devices.

1. Glass, comprising following components in mole percent: P₂O₅: 38 to 65%; Al₂O₃: 2 to 15%; CuO: 8 to 25%; Rn₂O: 5 to 40%; RO: 1 to 30%; and V₂O₅: 0 to 3%, wherein Li₂O/Rn₂O is 0.4 to 1.0, and (Li₂O+CuO)/P₂O₅ is 0.3 to 1.2; a content of Rn₂O is a total content of Li₂O, Na₂O, and K₂O; and a content of RO is a total content of MgO, CaO, SrO, and BaO.

2. The glass according to claim 1, further comprising following components in mole percent: SiO₂: 0 to 10%; and/or B₂O₃: 0 to 10%; and/or ZnO: 0 to 8%; and/or Ln₂O₃: 0 to 10%; and/or ZrO₂: 0 to 10%, wherein Ln₂O₃ is one or more of La₂O₃, Gd₂O₃, Y₂O₃, and Yb₂O₃.

3. Glass, comprising following components in mole percent: P₂O₅, Al₂O₃, CuO, and Rn₂O, wherein Li₂O/Rn₂O is 0.4 to 1.0, and (Li₂O+CuO)/P₂O₅ is 0.3 to 1.2; a content of Rn₂O is a total content of Li₂O, Na₂O, and K₂O; and the glass has an upper limit temperature of crystallization of 1050° C. or lower.

4. The glass according to claim 1, comprising the following components in mole percent: P₂O₅: 40 to 60%; and/or Al₂O₃: 5 to 13%; and/or CuO: 10 to 22%; and/or Rn₂O: 8 to 30%; and/or RO: 2 to 25%; and/or V₂O₅: 0.05 to 2%; and/or SiO₂: 0 to 5%; and/or B₂O₃: 0 to 5%; and/or ZnO: 0 to 5%; and/or Ln₂O₃: 0 to 5%; and/or ZrO₂: 0 to 5%, wherein the content of Rn₂O is the total content of Li₂O, Na₂O, and K₂O; the content of RO is the total content of MgO, CaO, SrO, and BaO; and Ln₂O₃ is one or more of La₂O₃, Gd₂O₃, Y₂O₃, and Yb₂O₃.

5. The glass according to claim 1, wherein the components in mole percent, Li₂O/Rn₂O is 0.5 to 1.0, and/or BaO/MgO is 0.05 to 5.0, and/or Li₂O/CuO is 0.3 to 3.0, and/or Na₂O+K₂O is 10% or less, and/or (Li₂O+CuO)/P₂O₅ is 0.4 to 1.0, and/or 10×V₂O₅/Li₂O is 0.02 to 3.0, and/or RO/CuO is 2.0 or less, and/or (Li₂O+BaO+CuO)/(Na₂O+K₂O+MgO+CaO+SrO) is 2.0 to 17.0; wherein the content of Rn₂O is the total content of Li₂O, Na₂O, and K₂O; and the content of RO is the total content of MgO, CaO, SrO, and BaO.

6. The glass according to claim 1, comprising the following components in mole percent: P₂O₅: 45 to 55%; and/or Al₂O₃: 6 to 11%; and/or CuO: 14 to 20%; and/or Rn₂O: 10 to 25%; and/or RO: 4 to 20%; and/or V₂O₅: 0.1 to 1%; and/or SiO₂: 0 to 2%; and/or B₂O₃: 0 to 2%; and/or ZnO: 0 to 2%; and/or Ln₂O₃: 0 to 2%; and/or ZrO₂: 0 to 2%, wherein the content of Rn₂O is the total content of Li₂O, Na₂O, and K₂O; the content of RO is the total content of MgO, CaO, SrO, and BaO; and Ln₂O₃ is one or more of La₂O₃, Gd₂O₃, Y₂O₃, and Yb₂O₃.

7. The glass according to claim 1, wherein the following components in mole percent, Li₂O/Rn₂O is 0.7 to 1.0, and/or BaO/MgO is 0.1 to 3.0, and/or Li₂O/CuO is 0.5 to 2.0, and/or Na₂O+K₂O is 8% or less, and/or (Li₂O+CuO)/P₂O₅ is 0.5 to 0.8, and/or 10×V₂O₅/Li₂O is 0.05 to 2.0, and/or RO/CuO is 0.2 to 1.5, and/or (Li₂O+BaO+CuO)/(Na₂O+K₂O+MgO+CaO+SrO) is 3.0 to 12.0; wherein the content of Rn₂O is the total content of Li₂O, Na₂O, and K₂O; and the content of RO is the total content of MgO, CaO, SrO, and BaO.

8. The glass according to claim 1, wherein the following components in mole percent, Li₂O/Rn₂O is 0.8 to 1.0, and/or BaO/MgO is 0.15 to 1.0, and/or Li₂O/CuO is 0.8 to 1.5, and/or Na₂O+K₂O is 5% or less, and/or 10×V₂O₅/Li₂O is 0.1 to 0.8, and/or RO/CuO is 0.3 to 1.0, and/or (Li₂O+BaO+CuO)/(Na₂O+K₂O+MgO+CaO+SrO) is 4.0 to 10.0; wherein the content of Rn₂O is the total content of Li₂O, Na₂O, and K₂O; and the content of RO is the total content of MgO, CaO, SrO, and BaO.

9. The glass according to claim 1, comprising the following components in mole percent, Li₂O: 6 to 30%; and/or Na₂O: 0 to 10%; and/or K₂O: 0 to 10%; and/or MgO: 1 to 15%; and/or CaO: 0 to 8%; and/or SrO: 0 to 8%; and/or BaO: 0 to 10%.

10. The glass according to claim 1, comprising the following components in mole percent, Li₂O: 12 to 20%; and/or Na₂O: 0 to 2%; and/or K₂O: 0 to 2%; and/or MgO: 4 to 10%; and/or CaO: 0 to 3%; and/or SrO: 0 to 3%; and/or BaO: 1 to 6%.

11. The glass according to claim 1, comprising the following components in mole percent, F: 0 to 5%; and/or Fe: 0 to 5%; and/or a refining agent: 0 to 1%, wherein the refining agent is one or more of Sb₂O₃, SnO₂, SnO, and CeO₂.

12. The glass according to claim 1, wherein the upper limit temperature of crystallization is 1040° C. or lower; and/or a transition temperature T_{g} is 405° C. or higher; and/or a density p is 3.1 g/cm³ or less; and/or a coefficient of thermal expansion α_{20-120° C.} is 98×10⁻⁷/K or less; and/or a wavelength 4), at which a transmittance of the glass with a thickness of 0.11 mm reaches 50%, is 622 to 650 nm; and/or a transmittance τ₄₀₀ of the 0.11 mm-thick glass at 400 nm is 73% or more; and/or a transmittance τ_{1,100} of the 0.11 mm-thick glass at 1,100 nm is 15% or less.

13. The glass according to claim 1, wherein the upper limit temperature of crystallization is 1030° C. or lower; and/or a transition temperature T_{g} is 415 to 450° C.; and/or a density p is 2.9 g/cm³ or less; and/or a coefficient of thermal expansion α_{20-120° C.} is 90×10⁻⁷/K or less; and/or a wavelength 4), at which a transmittance of the glass with a thickness of 0.11 mm reaches 50%, is 630 to 640 nm; and/or a transmittance τ₄₀₀ of the 0.11 mm-thick glass at 400 nm is 78% or more; and/or a transmittance τ_{1,100} of the 0.11 mm-thick glass at 1,100 nm is 10% or less.

14. A glass product, comprising following components in mole percent, P₂O₅: 38 to 65%; Al₂O₃: 2 to 15%; CuO: 8 to 25%; Rn₂O: 5 to 40%; RO: 1 to 30%; and V₂O₅: 0 to 3%, wherein Li₂O/Rn₂O is 0.4 to 1.0, and (Li₂O+CuO)/P₂O₅ is 0.3 to 1.2; a content of Rn₂O is a total content of Li₂O, Na₂O, and K₂O; and a content of RO is a total content of MgO, CaO, SrO, and BaO.

15. The glass product according to claim 14, further comprising the following components in mole percent: SiO₂: 0 to 10%; and/or B₂O₃: 0 to 10%; and/or ZnO: 0 to 8%; and/or Ln₂O₃: 0 to 10%; and/or ZrO₂: 0 to 10%, wherein Ln₂O₃ is one or more of La₂O₃, Gd₂O₃, Y₂O₃, and Yb₂O₃.

16. The glass product according to claim 14, comprising the following components in mole percent: P₂O₅: 40 to 60%; and/or Al₂O₃: 5 to 13%; and/or CuO: 10 to 22%; and/or Rn₂O: 8 to 30%; and/or RO: 2 to 25%; and/or V₂O₅: 0.05 to 2%; and/or SiO₂: 0 to 5%; and/or B₂O₃: 0 to 5%; and/or ZnO: 0 to 5%; and/or Ln₂O₃: 0 to 5%; and/or ZrO₂: 0 to 5%, wherein the content of Rn₂O is the total content of Li₂O, Na₂O, and K₂O; the content of RO is the total content of MgO, CaO, SrO, and BaO; and Ln₂O₃ is one or more of La₂O₃, Gd₂O₃, Y₂O₃, and Yb₂O₃.

17. The glass product according to claim 14, wherein the following components in mole percent, Li₂O/Rn₂O is 0.5 to 1.0, and/or BaO/MgO is 0.05 to 5.0, and/or Li₂O/CuO is 0.3 to 3.0, and/or Na₂O+K₂O is 10% or less, and/or (Li₂O+CuO)/P₂O₅ is 0.4 to 1.0; and/or 10×V₂O₅/Li₂O is 0.02 to 3.0, and/or RO/CuO is 2.0 or less, and/or (Li₂O+BaO+CuO)/(Na₂O+K₂O+MgO+CaO+SrO) is 2.0 to 17.0; wherein the content of Rn₂O is the total content of Li₂O, Na₂O, and K₂O; and the content of RO is the total content of MgO, CaO, SrO, and BaO.

18. The glass product according to claim 14, comprising the following components in mole percent, P₂O₅: 45 to 55%; and/or Al₂O₃: 6 to 11%; and/or CuO: 14 to 20%; and/or Rn₂O: 10 to 25%; and/or RO: 4 to 20%; and/or V₂O₅: 0.1 to 1%; and/or SiO₂: 0 to 2%; and/or B₂O₃: 0 to 2%; and/or ZnO: 0 to 2%; and/or Ln₂O₃: 0 to 2%; and/or ZrO₂: 0 to 2%, wherein the content of Rn₂O is the total content of Li₂O, Na₂O, and K₂O; the content of RO is the total content of MgO, CaO, SrO, and BaO; and Ln₂O₃ is one or more of La₂O₃, Gd₂O₃, Y₂O₃, and Yb₂O₃.

19. The glass product according to claim 14, wherein the following components in mole percent, Li₂O/Rn₂O is 0.7 to 1.0, and/or BaO/MgO is 0.1 to 3.0, and/or Li₂O/CuO is 0.5 to 2.0, and/or Na₂O+K₂O is 8% or less, and/or (Li₂O+CuO)/P₂O₅ is 0.5 to 0.8, and/or 10×V₂O₅/Li₂O is 0.05 to 2.0, and/or RO/CuO is 0.2 to 1.5, and/or (Li₂O+BaO+CuO)/(Na₂O+K₂O+MgO+CaO+SrO) is 3.0 to 12.0; wherein the content of Rn₂O is the total content of Li₂O, Na₂O, and K₂O; and the content of RO is the total content of MgO, CaO, SrO, and BaO.

20. The glass product according to claim 14, wherein the following components in mole percent: Li₂O/Rn₂O is 0.8 to 1.0, and/or BaO/MgO is 0.15 to 1.0, and/or Li₂O/CuO is 0.8 to 1.5, and/or Na₂O+K₂O is 5% or less, and/or 10×V₂O₅/Li₂O is 0.1 to 0.8, and/or RO/CuO is 0.3 to 1.0, and/or (Li₂O+BaO+CuO)/(Na₂O+K₂O+MgO+CaO+SrO) is 4.0 to 10.0; wherein the content of Rn₂O is the total content of Li₂O, Na₂O, and K₂O; and the content of RO is the total content of MgO, CaO, SrO, and BaO.

21. The glass product according to claim 14, wherein the following components in mole percent: Li₂O: 6 to 30%; and/or Na₂O: 0 to 10%; and/or K₂O: 0 to 10%; and/or MgO: 1 to 15%; and/or CaO: 0 to 8%; and/or SrO: 0 to 8%; and/or BaO: 0 to 10%.

22. The glass product according to claim 14, wherein the following components in mole percent: Li₂O: 12 to 20%; and/or Na₂O: 0 to 2%; and/or K₂O: 0 to 2%; and/or MgO: 4 to 10%; and/or CaO: 0 to 3%; and/or SrO: 0 to 3%; and/or BaO: 1 to 6%.

23. The glass product according to claim 14, wherein the following components in mole percent: F: 0 to 5%; and/or Fe: 0 to 5%; and/or a refining agent: 0 to 1%, wherein the refining agent is one or more of Sb₂O₃, SnO₂, SnO, and CeO₂.

24. The glass product according to claim 14, wherein the upper limit temperature of crystallization is 1050° C. or lower; and/or the transition temperature T_{g} is 405° C. or higher; and/or the density p is 3.1 g/cm³ or less; and/or the coefficient of thermal expansion α_{20-120° C.} is 98×10⁻⁷/K or less; and/or the wavelength 4), at which the transmittance of the glass product with a thickness of 0.11 mm reaches 50%, is 622 to 650 nm; and/or the transmittance τ₄₀₀ of the 0.11 mm-thick glass product at 400 nm is 73% or more; and/or the transmittance τ_{1,100} of the 0.11 mm-thick glass product at 1,100 nm is 15% or less; and/or the bending strength a of the 0.11 mm-thick glass product is 450 MPa or more.

25. The glass product according to claim 14, wherein the upper limit temperature of crystallization is 1030° C. or lower; and/or the transition temperature T_{g} is 415 to 450° C.; and/or the density p is 2.9 g/cm³ or less; and/or the coefficient of thermal expansion α_{20-120° C.} is 90×10⁻⁷/K or less; and/or the wavelength 4), at which the transmittance of the glass product with a thickness of 0.11 mm reaches 50%, is 630 to 640 nm; and/or the transmittance τ₄₀₀ of the 0.11 mm-thick glass product at 400 nm is 78% or more; and/or the transmittance τ_{1,100} of the 0.11 mm-thick glass product at 1,100 nm is 10% or less; and/or the bending strength a of the 0.11 mm-thick glass product is 520 to 700 MPa.

26. A glass element, containing the glass according to claim 1.

27. An optical filter, containing the glass according to claim 1.

28. A device, containing the glass according to claim 1.

29. A method for preparing a glass product, wherein glass is processed into a glass formed body with a certain thickness, and then the glass formed body is placed in an etching solution formed from NaOH and/or KOH solution.

30. The method for preparing a glass product according to claim 29, wherein a concentration of the etching solution is 3 to 40%, and/or an etching temperature is 50 to 150° C., and/or a chemical etching time is 1 to 60 minutes.

31. The method for preparing a glass product according to claim 29, wherein a concentration of the etching solution is 5 to 20%, and/or an etching temperature is 70 to 110° C., and/or an chemical etching time is 2 to 30 minutes.
